(19) United States
(12) Patent Application Publication
(10) Pub. No.: US 2023/0155671 A1
(43) Pub. Date: May 18, 2023

(54) TRANSMITTING RADIO WAVE CONFIRMATION METHOD, MOBILE STATION DEVICE AND TRANSMITTING RADIO WAVE CONFIRMATION PROGRAM IN SATELLITE COMMUNICATION SYSTEM

(71) Applicant: NIPPON TELEGRAPH AND TELEPHONE CORPORATION, Tokyo (JP)

(72) Inventors: Koichi HARADA, Musashino-shi, Tokyo (JP); Masaki SHIMA, Musashino-shi, Tokyo (JP); Hiroki SHIBAYAMA, Musashino-shi, Tokyo (JP); Fumihiro YAMASHITA, Musashino-shi, Tokyo (JP)

(73) Assignee: NIPPON TELEGRAPH AND TELEPHONE CORPORATION, Tokyo (JP)

(21) Appl. No.: 17/915,816

(22) PCT Filed: Jul. 17, 2020
(86) PCT No.: PCT/JP2020/027877

§ 371 Date: Sep. 29, 2022

(30) Foreign Application Priority Data
Mar. 30, 2020 (JP) PCT/JP2020/014704

(51) Int. Cl. H04B 7/185

(52) U.S. Cl. CPC H04B 7/18519; H04B 7/18528

(57) ABSTRACT

Provided is a transmission radio wave checking method for a satellite communication system provided with a portable station, wherein the portable station executes a transmission process of transmitting a test signal and a control signal with a first polarization at a designated transmit level to a communications satellite, a reception process of receiving the test signal and the control signal transmitted back from the communications satellite with a second polarization orthogonal to the first polarization, and a control process of starting the transmission of the test signal and the control signal with the first polarization at a transmit level lower than a predetermined value, and raising the transmit level to a predetermined value while checking whether or not the test signal and the control signal received back from the satellite conform to a predetermined condition. With this arrangement, a UAT can be completed by receiving and checking a UAT signal transmitted by the portable station and received back from the satellite, even in cases where a UAT cannot be performed with a satellite telecommunications carrier.

### TECHNICAL FIELD

The present invention relates to technology for checking transmission radio waves when a portable ground station initially connects to a communications satellite in a satellite communication system in a situation where communication with a satellite telecommunications carrier is unavailable due to an event such as a large-scale disaster.

### BACKGROUND ART

A very-small-aperture terminal (VSAT) system is known as satellite communication system provided with a portable ground station. A VSAT system uses a small, portable VSAT ground station provided with an antenna having a very small aperture to enable communication from locations where a communications satellite can be acquired, and consequently is utilized to secure communication during a disaster or the like. However, in the case of installing a portable ground station (referred to as a portable station), before putting the portable station into operation, it is necessary to adjust the antenna direction with respect to a target communications satellite and then perform an uplink access test (UAT) to check whether a connection with the target communications satellite is established with the correct antenna direction. In a UAT of the related art, the operator of the portable station adjusts properties such as the transmit level and the polarization angle of the portable station while receiving instructions from an operator of the satellite telecommunications carrier over a mobile phone or a satellite phone (for example, see Non-Patent Literature 1). Alternatively, a control station that controls settings and operations for the entire system, such as a plurality of portable stations and base stations constituting a satellite communication system, monitors properties such as the transmit level and the polarization angle through a test signal (UAT signal) transmitted from a portable station, and by remotely adjusting the transmit level and the polarization angle of the portable station using a dedicated control channel (common signaling channel (CSC)), the control station performs a remote UAT that does not require an operator of the portable station (for example, see Patent Literature 1).

### CITATION LIST

### Patent Literature

Patent Literature 1: Japanese Patent Laid-Open No. 2012-175217

### Non-Patent Literature

Non-Patent Literature 1: Uplink Access Test Procedure (October 2009/SKY Perfect JSAT Corporation)

### SUMMARY OF THE INVENTION

### Technical Problem

In the technology of the related art, there is a problem of being unable to perform a UAT for a portable station in certain cases, such as when an operator of the satellite telecommunications carrier cannot be contacted due to an event such as a large-scale disaster, or in the case of a system in which the control station does not support all remote UAT functions. On the other hand, in cases where it is necessary to operate a portable station during a large-scale disaster, there is demand for a technology that checks whether properties such as the satellite acquisition state and transmission output are appropriate without affecting other radio communication users, even if a UAT cannot be performed with the satellite telecommunications carrier.

An objective of the present invention is to provide a transmission radio wave checking method for a satellite communication system, a portable station, and a transmission radio wave checking program capable of completing a UAT by receiving and checking a signal transmitted by a portable station and received back from a satellite, even in cases where a UAT cannot be performed with the satellite telecommunications carrier.

### Means for Solving the Problem

One aspect of the present invention is a transmission radio wave checking method for a satellite communication system provided with a portable station, wherein the portable station executes a transmission process of transmitting a test signal and a control signal with a first polarization at a designated transmit level to a communications satellite, a reception process of receiving the test signal and the control signal transmitted back from the communications satellite with a second polarization orthogonal to the first polarization, and a control process of starting the transmission of the test signal and the control signal with the first polarization at a transmit level lower than a predetermined value, and raising the transmit level to a predetermined value while checking whether or not the test signal and the control signal received back from the satellite conform to a predetermined condition.

Another aspect of the present invention is a portable station used in a satellite communication system, the portable station comprising a transmission unit that transmits a test signal and a control signal with a first polarization at a designated transmit level to a communications satellite, a reception unit that receives the test signal and the control signal transmitted back from the communications satellite with a second polarization orthogonal to the first polarization, and a control unit that starts the transmission of the test signal and the control signal with the first polarization at a transmit level lower than a predetermined value, and raises the transmit level to a predetermined value while checking whether or not the test signal and the control signal received back from the satellite conform to a predetermined condition.

Also, a transmission radio wave checking program according to the present invention causes a computer to execute a process executed according to the transmission radio wave checking method.

### Effects of the Invention

The transmission radio wave checking method for a satellite communication system, portable station, and transmission radio wave checking program according to the present invention is capable of completing a UAT by receiving and checking a signal transmitted by a portable station and received back from a satellite, even in cases where a UAT cannot be performed with the satellite telecommunications carrier.

### BRIEF DESCRIPTION OF DRAWINGS

FIG. 1 is a diagram illustrating an example of a satellite communication system common to the embodiments.

FIG. 2 is a diagram illustrating a configuration example for the case of an ordinary UAT.

FIG. 3 is a diagram illustrating another configuration example for the case of an ordinary UAT.

FIG. 4 is a diagram illustrating an example of a Kᵤ-band uplink channel.

FIG. 5 is a diagram illustrating a configuration example of a portable station (master station) according to a first embodiment.

FIG. 6 is a diagram illustrating a configuration example of a portable station (slave station) common to the embodiments.

FIG. 7 is a diagram illustrating an example of a UAT signal checking and adjustment process according to the first embodiment.

FIG. 8 is a diagram illustrating an example of a control signal checking and adjustment process according to the first embodiment.

FIG. 9 is a diagram illustrating a configuration example of a portable station (master station) according to a second embodiment.

FIG. 10 is a diagram illustrating an example of a UAT signal checking and adjustment process according to the second embodiment.

FIG. 11 is a diagram illustrating an example of a control signal checking and adjustment process according to the second embodiment.

### DESCRIPTION OF EMBODIMENTS

Hereinafter, embodiments of a transmission radio wave checking method for a satellite communication system, a portable station, and a transmission radio wave checking program according to the present invention will be described with reference to the drawings.

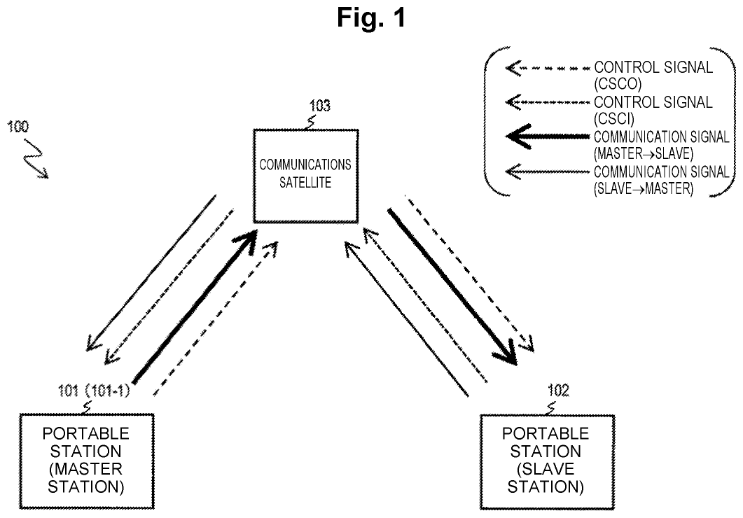

FIG. 1 illustrates an example of a satellite communication system 100 common to the embodiments. Each of the embodiments herein assumes a satellite communication system 100 like the following, for example. Note that although a portable station 101 is described in the first embodiment and a portable station 101-1 is described in the second embodiment described later, but because the functions of the satellite communication system 100 are the same, the portable station is described herein as the portable station 101 which also includes the portable station 101-1. The portable station 101 functions as a control station and also as a master station corresponding to a base station of an ordinary VSAT system, while a portable station 102 is a slave station corresponding to a VSAT ground station of an ordinary VSAT system. Additionally, the portable station 101 acting as a master station and the portable station 102 acting as a slave station construct a private network through P-P or P-MP communication, and the satellite communication system 100 is configured without an operation system provided by a control station or the like. For example, in the satellite communication system 100 in FIG. 1, the slave station (portable station 102) communicates with the master station by synchronizing with a control signal transmitted from the master station (portable station 101) through a communications satellite 103. Note that in the case where there are a plurality of slave stations similar to the portable station 102, the slave stations can communicate under control by the master station in a similar way.

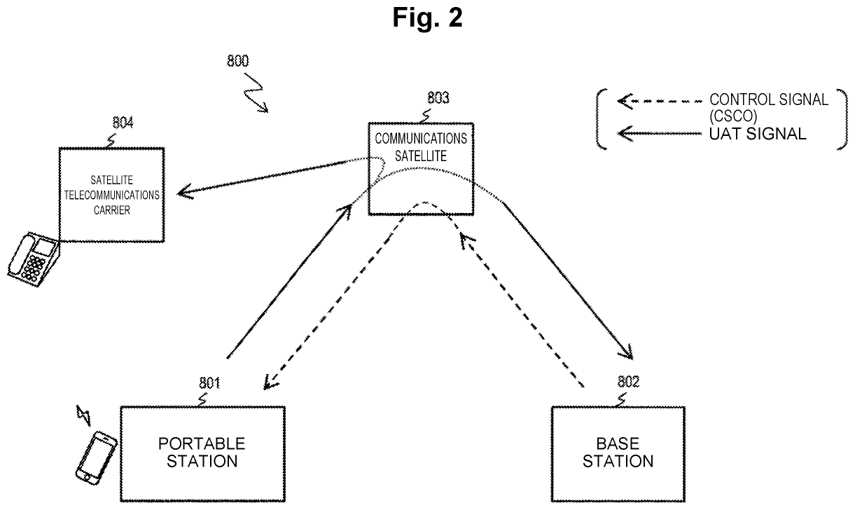

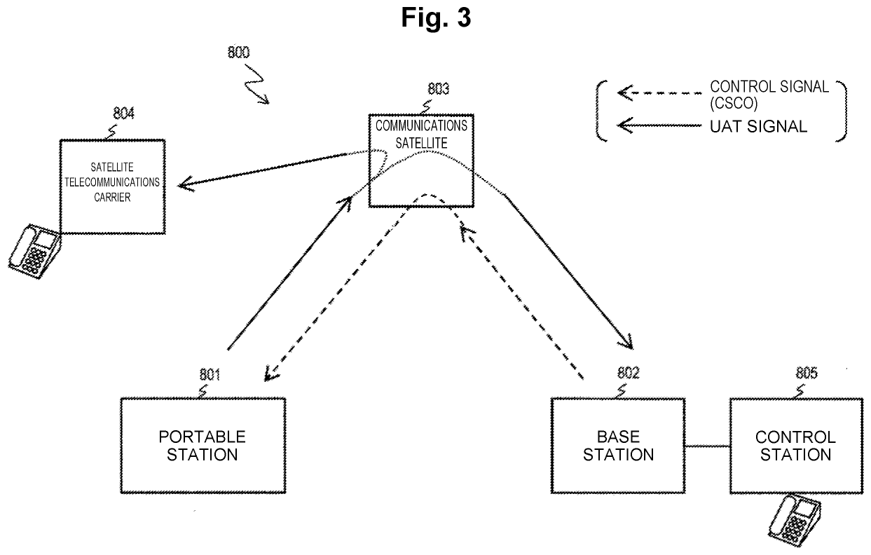

In FIG. 1, because the satellite communication system 100 is provided with a plurality of portable ground stations (in FIG. 1, the portable station 101 and the portable station 102) that can be used if in a location where the communications satellite 103 is acquirable, the satellite communication system 100 is effective for securing communication during a disaster or the like. However, in the case of performing initial operations of a portable station, it is necessary to perform checking and adjustment work referred as an uplink access test (UAT) to check whether properties such as the satellite acquisition state and the transmission output are appropriate without affecting other satellite communication users. Note that in the case of using a portable station as a slave station, if a UAT is performed during initial operations and an acknowledgment is obtained from the satellite telecommunications carrier, a UAT does not have to be performed during later operations. However, in the case of using a portable station as a master station, it is necessary to perform a UAT every time operations are performed. For example, FIG. 2 illustrates a configuration example for the case of an ordinary UAT. In an ordinary satellite communication system 800 provided with a portable station 801, a base station 802, a communications satellite 803, and a satellite telecommunications carrier 804, an operator of the portable station 801 contacts an operator of the satellite telecommunications carrier 804 over a mobile phone or a satellite phone, and the operator of the portable station 801 adjusts properties such as the transmit level and the polarization angle of a UAT signal (test signal) him- or herself. Alternatively, FIG. 3 illustrates another configuration example for the case of an ordinary UAT. In the case of performing a UAT without an operator of the portable station 801, an operator of a control station 805 contacts an operator of the satellite telecommunications carrier 804 and remotely controls the portable station 801 through a control signal (CSCO signal) from the base station 802 to adjust the transmit level and polarization angle of the UAT signal transmitted by the portable station 801.

In contrast, in the satellite communication system 100 common to the embodiments illustrated in FIG. 1, even in cases where a UAT with the satellite telecommunications carrier cannot be performed due to a large-scale disaster or the like, one portable station (in FIG. 1, the portable station 101) from among a plurality of portable stations acts as a master station and performs the operations of a base station and a control station by itself, and receives a UAT signal and a control signal transmitted by the portable station 101 itself instead of the satellite telecommunications carrier and received back from the communications satellite 103, and thereby can check and make adjustments similar to the case of an ordinary UAT. Here, the UAT includes two checking processes, namely a process of checking the UAT signal and a process of checking the control signal, and in the case where each signal conforms to a predetermined condition, the UAT is completed, and operation is started. Note that when the UAT is completed, the portable station 101 saves a UAT result together with the antenna direction and polarization angle state, which can be treated as evidence for starting operation of the portable station 101 on the basis of an appropriate UAT result.

In FIG. 1, the portable station 101 acting as the master station operates performs a UAT after completing adjustment of the antenna direction toward the communications satellite 103 every time the portable station 101 operates, whereas if the portable station 102 acting as a slave station has obtained an acknowledgment from the satellite telecommunications carrier, the portable station has performed a UAT according to a method of the related art during initial operations (when the device is used for the first time), the portable station 102 only has to adjust the antenna direction during subsequent operations, and does not need to perform a UAT every time the portable station 102 operates. The portable station 102 is an ordinary VSAT ground station that receives a control signal (CSCO signal) transmitted by the portable station 101 acting as the master station instead of the base station 802, and is capable of adjusting the antenna direction and operating without a UAT according to a beacon signal from the communications satellite 103 and the control signal from the portable station 101.

In FIG. 1, after the antenna direction adjustment is completed, the portable station 101 transmits a UAT signal and a control signal (CSCO signal) as the master station to the communications satellite 103. The communications satellite 103 transmits the signals received from the portable station 101 back to ground after performing frequency conversion, thereby enabling the portable station 101 to receive the UAT signal and the control signal transmitted by the portable station 101 itself back from the communications satellite 103, and perform adjustment and checking similar to an ordinary UAT. Note that the uplink from ground to satellite (the 14 GHz band, for example) and the downlink from satellite to ground (the 12 GHz band, for example) have a plurality of channels according to the satellite transponder of the communications satellite 103, and each portable station uses a channel assigned by the satellite telecommunications carrier in advance to transmit a UAT signal and a control signal suited to the satellite telecommunications carrier. For example, properties such as the polarization (such as V-polarized transmission), the frequency (such as f1 GHz), and the level (such as β dBm) are determined as the information of the UAT signal suited to the satellite telecommunications carrier in advance. Similarly, properties such as the polarization (such as the V-polarized transmission), the center frequency (such as f2 GHz), the bandwidth (such as xx kHz), the level (such as α dBm), and the radio wave type (such as xx K0G1D) are determined as the information of the control signal suited to the satellite telecommunications carrier in advance.

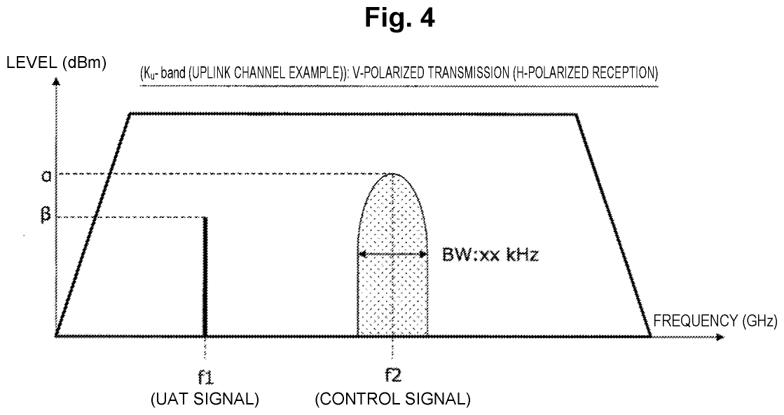

FIG. 4 illustrates an example of a Kᵤ-band uplink channel. In FIG. 4, the vertical axis represents level (dBm), the horizontal axis represents frequency (GHz), and the graph illustrates a representation of a UAT signal having a frequency of f1 GHz and a level of β dBm, and a representation of a control signal having a center frequency of f2 GHz, a bandwidth (BW) of xx kHz, and a level of α dBm. Note that although FIG. 4 illustrates representations of a UAT signal and a control signal, a predetermined bandwidth is also allocated similarly to a communication signal (user data communication such as telephony). Also, in FIG. 1, the uplink radio waves transmitted from the portable station 101 to the communications satellite 103 are V-polarized waves at 14 GHz for example, while the downlink radio waves transmitted back to the portable station 101 from the communications satellite 103 are H-polarized waves at 12 GHz, for example. Here, the signals transmitted or received between the ground and the satellite are for different users for each polarization even if the frequency is the same, and therefore correct polarization adjustment is important.

### First Embodiment

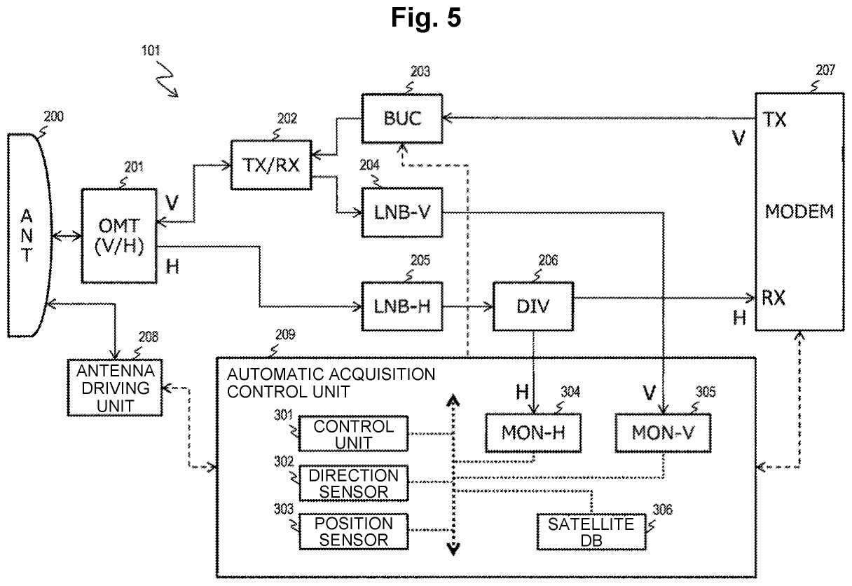

FIG. 5 is a diagram illustrating a configuration example of a portable station 101 (master station) according to the first embodiment. The portable station 101 includes an antenna (ANT) 200, a polarization duplexer (OMT (V/H)) 201, a transmit/receive demultiplexer (TX/RX) 202, a transmitter (BUC) 203, a low-noise amplifier (LNB-V) 204, a low-noise amplifier (LNB-H) 205, a divider (DIV) 206, a modulator-demodulator (MODEM) 207, an antenna driving unit 208, and an automatic acquisition control unit 209. FIG. 5 illustrates an example in which the V polarization is the forward polarization in the transmit system and the H polarization is the forward polarization in the receive system. Note that forward polarization is the polarization in the direction of travel of the radio wave, and in the first embodiment, radio waves transmitted from the portable station 101 to the communications satellite 103 have the V polarization in the forward direction, and radio waves transmitted from the communications satellite 103 to the portable station 101 have the H polarization in the forward direction. Here, the V polarization corresponds to a first polarization and the H polarization orthogonal to the V polarization corresponds to a second polarization.

The ANT 200 is an antenna such as a parabolic antenna that includes an antenna driving mechanism for adjusting the direction under control by the antenna driving unit 208, and transmits and receives wireless radio waves with respect to the communications satellite 103. Note that ANT is an abbreviation of ANTenna.

The OMT (V/H) 201 is a polarization duplexer that splits radio waves into a V-polarized signal and an H-polarized signal, and functions bidirectionally for transmission and reception. For example, a signal received by the ANT 200 is outputted to the TX/RX 202 and the LNB-H 205, while a signal transmitted from the TX/RX 202 is outputted to the TX/RX 202. Note that OMT is an abbreviation of Ortho Mode Transducer.

The TX/RX 202 is a transmit/receive demultiplexer that splits a signal into a transmit signal and a receive signal.

The BUC 203 is a transmitter combining a high power amplification function with a function of frequency-converting a signal in the 1.2 GHz band outputted by the MODEM 207 to the 14 GHz band, for example. Note that BUC is an abbreviation of Block Up Converter.

The LNB-V 204 is a low-noise amplifier combining a function of amplifying with low noise a V-polarized signal in the 12 GHz band received by the ANT 200 with a function of converting the frequency to the 1.2 GHz band, for example. Note that LNB is an abbreviation of Low Noise Block converter.

The LNB-H 205 is a low-noise amplifier combining a function of amplifying with low noise an H-polarized signal in the 12 GHz band received by the ANT 200 with a function of converting the frequency to the 1.2 GHz band, for example. Here, the blocks from the ANT 200 to the LNB-V 204 and the LNB-H 205 correspond to a reception unit.

The DIV 206 is a divider that divides and outputs an inputted signal into two signals. Note that DIV is an abbreviation of DIVider.

The MODEM 207 is a modulator-demodulator that converts and transmits data signals at a communication rate of 384 kbit/s and also receives and demodulates a modulated signal into a data signal at a communication rate of 1.5 Mbit/s, for example. Note that MODEM is an abbreviation of MOdulator-DEModulator. Here, the blocks from the MODEM 207 and the BUC 203 to the ANT 200 correspond to a transmission unit.

The antenna driving unit 208 causes the antenna driving mechanism of the ANT 200 to operate on the basis of commands from the automatic acquisition control unit 209, and thereby adjusts the three directions of the azimuth, the elevation, and the polarization angle. Note that the azimuth is an angle centered on the antenna and turning to the east from true north (corresponding to longitude), the elevation is an angle going upward from the horizontal plane, and the polarization angle is an angle obtained between the horizontal plane and the polarization plane of arriving radio waves.

The automatic acquisition control unit 209 has a computer function that executes a program stored in advance with a control unit 301, and executes processes such as automatic acquisition of the communications satellite 103 and adjustment and checking during operations. For example, the automatic acquisition control unit 209 controls the transmit level of the BUC 203, controls the modulation-demodulation processing by the MODEM 207, controls the antenna driving unit 208, and the like in the portable station 101.

In FIG. 5, the automatic acquisition control unit 209 includes the control unit 301, a direction sensor 302, a position sensor 303, a MON-H 304, a MON-V 305, and a satellite DB 306.

The control unit 301 operates on the basis of a program stored internally in advance, and cooperates with the units of the direction sensor 302, the position sensor 303, the MON-H 304, the MON-V 305, and the satellite DB 306 to adjust the antenna direction with the antenna driving unit 208 and perform a UAT. In addition, the control unit 301 adjusts the transmit level of the BUC 203, controls the MODEM 207 (such as transmitting a continuous wave (CW) and specifying the modulation-demodulation scheme), and the like.

The direction sensor 302 is a sensor that measures the azimuth (east longitude) of the ANT 200. For example, the direction sensor 302 measures the current azimuth of the ANT 200 obtained from the antenna driving unit 208 on the basis of information obtained from an azimuth compass or the like. Here, the azimuth corresponds to longitude.

The position sensor 303 is a sensor that measures the installation location (latitude and longitude) of the portable station 101. A system such as the Global Positioning System (GPS) is used, for example.

The MON-H 304 includes a measuring instrument (such as a spectrum analyzer, for example) capable of measuring the receive level, the frequency, and the bandwidth, and measures the receive level, the frequency, and the bandwidth of an H-polarized signal outputted from the DIV 206.

Like the MON-H 304, the MON-V 305 includes a measuring instrument (such as a spectrum analyzer, for example) capable of measuring the receive level, the frequency, and the bandwidth, and measures the receive level, the frequency, and the bandwidth of a V-polarized signal outputted from the LNB-V 204.

The satellite DB 306 is a database including a storage medium such as a hard disk or a memory. For example, information such as position information (such as the east longitude) and beacon signal information (such as the polarization and frequency) of each satellite is stored as satellite information for a plurality of communications satellites including the communications satellite 103. The satellite DB 306 also stores information about a UAT signal (such as the polarization, frequency, and level) suited to the satellite telecommunications carrier in advance and information about a control signal (such as the polarization, center frequency, bandwidth, level, and radio wave type) suited to the satellite telecommunications carrier in advance.

Here, because the core of the satellite communication system 100 according to the first embodiment is the technology related to the UAT performed after the adjustment of the antenna direction is completed, a detailed description of the method for adjusting the antenna direction is omitted. The control unit 301 of the automatic acquisition control unit 209 controls the three directions of the azimuth, the elevation, and the polarization angle of the ANT 200 with the antenna driving unit 208 while also measuring the installation location (latitude and longitude) of the ANT 200 acquired from the position sensor 303 and the direction (east longitude) of the ANT 200 acquired from the direction sensor 302, and makes adjustments such that the ANT 200 points in the direction of a target communications satellite (communications satellite 103) stored in the satellite DB 306.

In this way, the portable station 101 according to the first embodiment can adjust the antenna direction and perform a UAT as the master station on the basis of a program stored in advance in the control unit 301 of the automatic acquisition control unit 209.

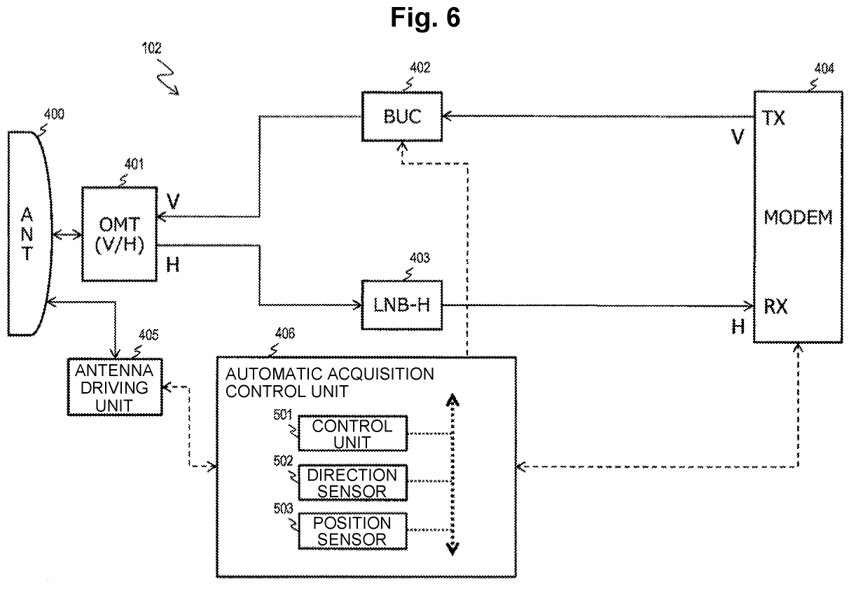

FIG. 6 illustrates a configuration of the portable station 102 (slave station). The portable station 102 acting as a slave station includes an antenna (ANT) 400, a polarization duplexer (OMT (V/H)) 401, a transmitter (BUC) 402, a low-noise amplifier (LNB-H) 403, a modulator-demodulator (MODEM) 404, an antenna driving unit 405, and an automatic acquisition control unit 406. FIG. 6 illustrates an example in which transmit system has the V polarization in the forward direction and the receive system has the H polarization in the forward direction.

Note that the portable station 102 has a configuration similar to the ordinary portable station 801, and communicates a control signal with the base station 802 to establish synchronization and thereby transmit and receive a communication signal. In the case where the base station 802 is nonfunctional, such as during a large-scale disaster, the portable station 102 can communicate a control signal with another portable station (in the first embodiment, the portable station 101) that operates as the master station instead of the base station 802 to establish synchronization and thereby transmit and receive a communication signal. Here, the portable station 102 acting as a slave station performs a remote UAT with the master station (portable station 101) when the portable station 102 is introduced, and if an acknowledgment is obtained from the satellite telecommunications carrier, the portable station 102 is exempted from performing the UAT for subsequent operations by automatically adjusting the antenna and then synchronizing with the control signal (CSCO signal) from the master station.

In FIG. 6, the ANT 400, the OMT (V/H) 401, the BUC 402, the LNB-H 403, the MODEM 404, and the antenna driving unit 405 have functions similar to the ANT 200, the OMT (V/H) 201, the BUC 203, the LNB-H 205, the MODEM 207, and the antenna driving unit 208 described in FIG. 5. The automatic acquisition control unit 406 includes a control unit 501, a direction sensor 502, and a position sensor 503. Note that the direction sensor 502 and the position sensor 503 have functions similar to the direction sensor 302 and the position sensor 303 of the automatic acquisition control unit 209 described in FIG. 5.

The control unit 501 calculates the three directions of the azimuth, the elevation, and the polarization angle of the ANT 400 to be adjusted on the basis of the installation location (latitude and longitude) of the ANT 400 acquired from the position sensor 503 and the current direction (longitude) of the ANT 400 acquired from the direction sensor 502, and adjusts the ANT 400 with the antenna driving unit 405 such that the direction of the ANT 400 points in the direction of the target communications satellite 103 stored in advance. Thereafter, the control unit 501 receives a control signal (CSCO signal) from the portable station 101 acting as the master station through the MODEM 404, and establishes synchronization.

In this way, the portable station 102 acting as a slave station can adjust the antenna direction and establish synchronization with the portable station 101 acting as the master station, and communicate with the portable station 101 or another portable station.

Next, an example of a UAT process performed after the completion of the antenna direction adjustment in the portable station 101 according to the first embodiment will be described.

[Example of UAT Process According to First Embodiment]

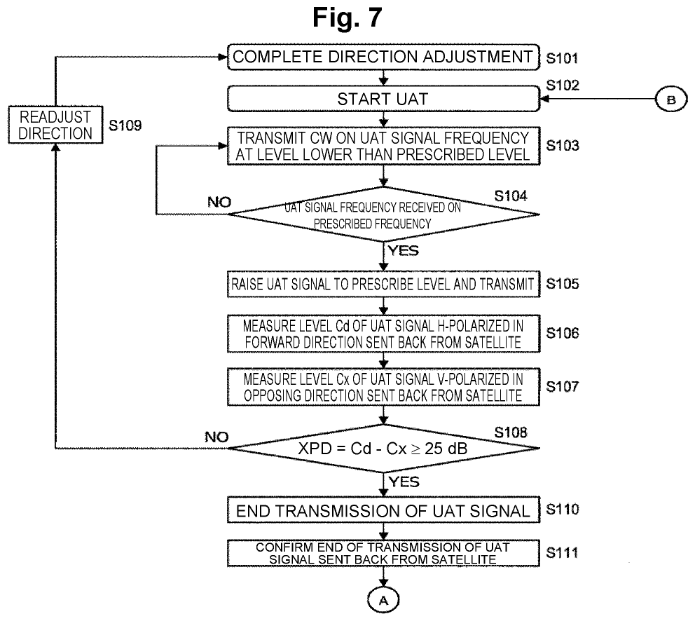

FIG. 7 illustrates an example of a UAT signal checking and adjustment process according to the first embodiment. Note that the process in FIG. 7 is performed between the portable station 101 and the communications satellite 103 illustrated in FIG. 1, and is executed by a program stored in advance in the control unit 301 of the automatic acquisition control unit 209 in the portable station 101 illustrated in FIG. 5.

In step S101, the operator of the portable station 101 completes adjustment of the antenna direction. Here, because the core of the satellite communication system 100 according to the first embodiment is the technology related to the UAT performed after the adjustment of the antenna direction is completed, a detailed description of the method for adjusting the antenna direction is omitted. For example, the control unit 301 of the automatic acquisition control unit 209 calculates the three directions of the azimuth, the elevation, and the polarization angle of the ANT 200 to be installed on the basis of the installation location (latitude and longitude) of the ANT 200 acquired from the position sensor 303 and the current azimuth of the ANT 200 acquired from the direction sensor 302, and adjusts the ANT 200 with the antenna driving unit 208 to point in the direction (longitude) of the target communications satellite 103 stored in the satellite DB 306.

In step S102, the control unit 301 of the portable station 101 starts a UAT.

In step S103, the control unit 301 references the satellite DB 306, outputs a CW on a predetermined UAT signal frequency from the MODEM 207, and transmits a V-polarized UAT signal to the communications satellite 103 at a predetermined level lower than a prescribed level from the BUC 203 (transmit process). Here, the communications satellite 103 converts the frequency of the UAT signal transmitted from the portable station 101, and transmits the converted UAT signal back to ground. Note that when sending back the UAT signal, the polarization is converted from V polarization to H polarization.

In step S104, the control unit 301 uses the MON-H 304 to receive the UAT signal having the H polarization in the forward direction received back from the communications satellite 103 (receive process), and determines whether or not the frequency of the UAT signal is a prescribed frequency determined in advance. In the case where the reception of the UAT signal at the prescribed frequency is confirmed, the flow proceeds to the process in step S105, whereas in the case where the reception is not confirmed, the flow returns to step S103, and a similar process is repeated until the UAT signal is confirmed successfully. Note that if the UAT signal is not confirmed successfully within a certain time, an error notification may be issued to the operator.

In step S105, the control unit 301 controls the BUC 203 to raise the UAT signal to a prescribed level and transmit the UAT signal to the communications satellite 103.

In step S106, the portable station 101 measures the receive level Cd of the UAT signal having the H polarization in the forward direction of the UAT signal received back from the communications satellite 103.

In step S107, the control unit 301 uses the MON-V 305 to receive and measure the level Cx of cross-talk into the V polarization in the opposing direction of the UAT signal received back from the communications satellite 103.

In step S108, the control unit 301 calculates the cross-polarization discrimination XPD according to Expression (1).

XPD=Cd−Cx (1)

Additionally, the control unit 301 determines whether or not the cross-polarization discrimination XPD is at or above a predetermined threshold (for example, XPD≥25 dB). In the case where XPD≥25 dB, the flow proceeds to the process in step S110, whereas in the case where XPD<25 dB, it is determined that the adjustment of the antenna direction is incomplete and the flow proceeds to the process in step S109 (control process).

In step S109, because the adjustment of the antenna direction has been determined to be incomplete in step S108, the control unit 301 readjusts the antenna direction, returns to the process in step S101, and executes a similar process.

In step S110, the control unit 301 controls the MODEM 207 and the BUC 203 to stop the transmission of the UAT signal (end transmission).

In step S111, the control unit 301 uses the MON-H 304 to confirm that the transmission of the UAT signal received back from the communications satellite 103 has ended, and proceeds to the process in (A).

In this way, even in the case where a UAT with the satellite telecommunications carrier cannot be performed, the portable station 101 according to the first embodiment can receive a UAT signal transmitted by the portable station 101 itself and received back from the communications satellite 103 to adjust and check the transmit level and the polarization, similarly to an ordinary UAT. At this point, because the checking of the UAT signal is completed, the portable station 101 performs a process of checking the control signal next.

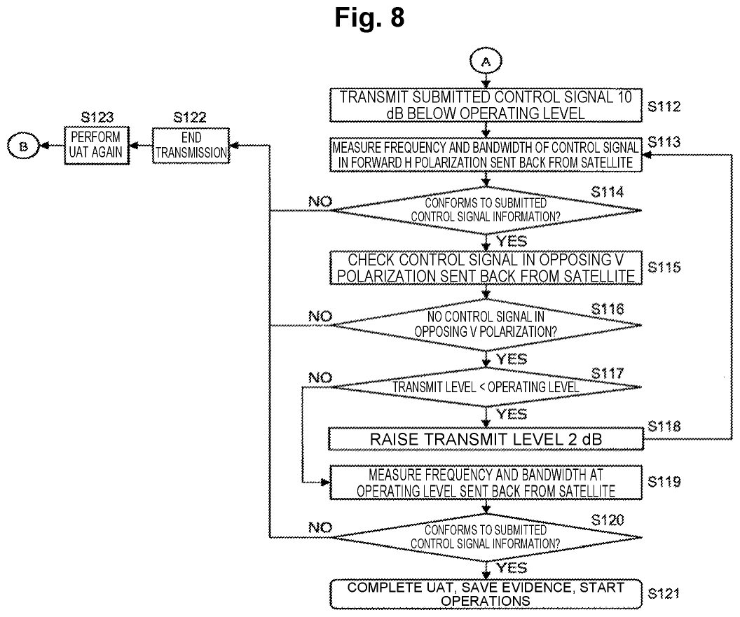

FIG. 8 illustrates an example of a control signal checking and adjustment process. Note that the process in FIG. 8 is performed between the portable station 101 and the communications satellite 103, and is executed by a program stored in advance in the control unit 301 of the automatic acquisition control unit 209 in the portable station 101 illustrated in FIG. 5.

In step S112, the control unit 301 references the satellite DB 306, outputs a control signal (CSCO signal) submitted to the satellite telecommunications carrier in advance from the MODEM 207, and transmits the control signal as a V-polarized signal to the communications satellite 103 at a predetermined level lower than the operating level (here, a level 10 dB lower than the operating level) from the BUC 203 (transmit process). Here, the communications satellite 103 converts the frequency of the control signal transmitted from the portable station 101, and transmits the converted control signal back to ground. Note that when sending back the control signal, the polarization is converted from V polarization to H polarization.

In step S113, the control unit 301 uses the MON-H 304 to receive the control signal having the H polarization in the forward direction received back from the communications satellite 103 (receive process), and measures the frequency (center frequency) and the bandwidth of the control signal.

In step S114, the control unit 301 determines whether or not the frequency and the bandwidth of the control signal measured in step S113 conform to the information (prescribed values) of the control signal submitted to the satellite telecommunications carrier. If the control signal is in conformance, the flow proceeds to the process in step S115, and if not, the flow proceeds to the process in step S122 (control process).

In step S115, the control unit 301 measures the level of cross-talk into the V polarization in the opposing direction of the H polarization in the forward direction included in the signal sent back from the communications satellite 103 and received by the MON-H 304. At this point, a control signal having the V polarization is not measured if the polarization of the control signal has been adjusted correctly, but a control signal having the V polarization is measured if the polarization has not been adjusted correctly.

In step S116, the control unit 301 determines the presence or absence of a control signal having the V polarization in the opposing direction measured in step S115. If a control signal having the V polarization does not exist, the flow proceeds to the process in step S117, whereas if a control signal having the V polarization exists, the flow proceeds to the process in step S122. Note that a control signal having the V polarization may be determined not to exist in the case where the measured level of the control signal having the V polarization is below a preset threshold.

In step S117, the control unit 301 determines whether or not the transmit level of the transmitted control signal is less than the operating level. In the case where transmit level<operating level, the flow proceeds to the process in step S118, whereas in the case where transmit level≥operating level, the flow proceeds to the process in step S119 (control process).

In step S118, the control unit 301 controls the BUC 203 to raise the transmit level of the control signal 2 dB and transmit the control signal to the communications satellite 103, then returns to the process in step S113.

In step S119, the control unit 301 uses the MON-H 304 to receive the control signal having the H polarization in the forward direction received back from the communications satellite 103, and measures the frequency (center frequency) and the bandwidth of the control signal at the operating level.

In step S120, the control unit 301 determines whether or not the frequency and the bandwidth of the control signal at the operating level measured in step S119 conform to the information (prescribed values) of the control signal submitted to the satellite telecommunications carrier. If the control signal is in conformance, the flow proceeds to the process in step S121, and if not, the flow proceeds to the process in step S122 (control process).

In step S121, the control unit 301 completes the UAT started in step S102 of FIG. 7, saves the measurement values of the UAT signal measured in steps S106, S107, and S108 and the measurement values of the control signal measured in step S119 to the satellite DB 306 as UAT evidence, and starts operations (control process).

In step S122, in the case where NO is determined in step S114, S116, or S120, the control unit 301, the control unit 301 controls the MODEM 207 and the BUC 203 to stop the transmission of the control signal (end transmission).

In step S123, the control unit 301 uses the MON-H 304 to confirm that the transmission of the control signal received back from the communications satellite 103 has ended, and returns to the process in (B) of FIG. 7 to perform the UAT again.

In this way, even in the case where a UAT with the satellite telecommunications carrier cannot be performed, the portable station 101 according to the first embodiment can receive a UAT signal and a control signal transmitted by the portable station 101 itself and received back from the communications satellite 103 to adjust and check the transmit level and the polarization of the UAT signal as described in FIG. 7 and also adjust and check the frequency, the polarization, and the bandwidth of the control signal as described in FIG. 8, similarly to an ordinary UAT. In particular, because the portable station 101 according to the first embodiment raises the transmit level of the control signal gradually by 2 dB at a time while checking whether or not the control signal conforms to the control signal information submitted to the satellite telecommunications carrier, operations can be started without affecting other satellite communication users. Also, in the first embodiment, both the V polarization and the H polarization are measured through the signals sent back from the communications satellite 103, and it can be confirmed that the polarization in the opposing direction (opposite polarization) is not being affected.

Here, a program corresponding to the processes described in FIGS. 7 and 8 may also be executed by a computer. In addition, the program may be provided by being recorded onto a storage medium or may be provided over a network.

### Second Embodiment

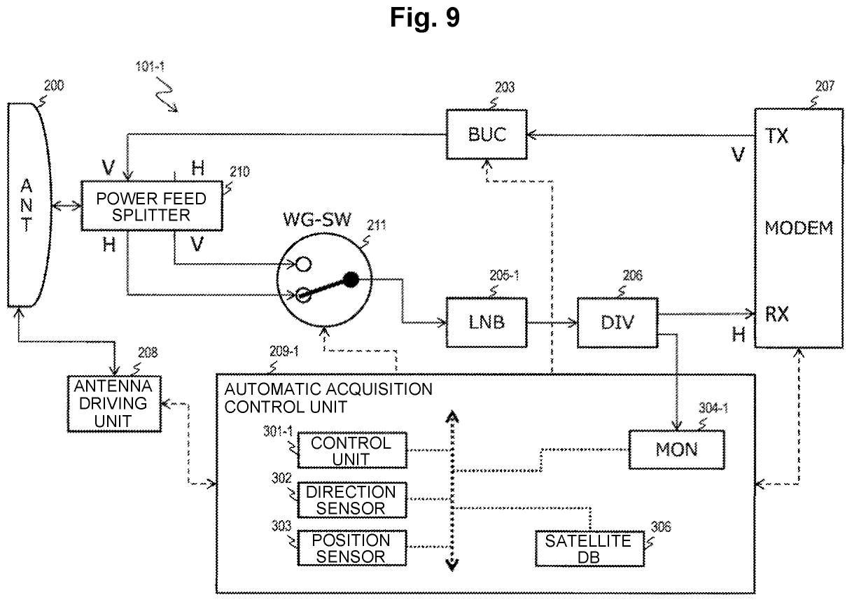

FIG. 9 is a diagram illustrating a configuration example of a portable station 101-1 (master station) according to the second embodiment. In FIG. 9, the blocks (ANT 200, BUC 203, DIV 206, MODEM 207, and antenna driving unit 208) having the same signs as the portable station 101 according to the first embodiment described in FIG. 5 operate similarly to FIG. 5, and consequently a duplicate description is omitted. In addition to the blocks described above, the portable station 101-1 according to the second embodiment includes a low-noise amplifier (LNB) 205-1 that has a different name but the same operation as the first embodiment, an automatic acquisition control unit 209-1 that has the same name but slightly different operation from the first embodiment, and a power feed splitter 210 and a waveguide switch (WG-SW) 211 as new blocks.

The LNB 205-1 is a low-noise amplifier have a function similar to the LNB-V 204 and the LNB-H 205 in FIG. 5. The LNB 205-1 amplifies with low noise a V-polarized or H-polarized signal received by the ANT 200 and inputted through the power feed splitter 210 and the WG-SW 211. Furthermore, the LNB 205-1 is a low-noise amplifier including an integrated function of frequency-converting a signal in the 12 GHz band to a signal in the 1.2 GHz band, for example. Here, the blocks from the ANT 200 to the LNB 205-1 correspond to a reception unit.

Like the automatic acquisition control unit 209 described in FIG. 5, the automatic acquisition control unit 209-1 has a computer function that executes a program stored in advance with a control unit 301-1, and executes processes such as automatic acquisition of the communications satellite 103 and adjustment and checking during operations. For example, the automatic acquisition control unit 209-1 controls the transmit level of the BUC 203, controls the modulation-demodulation processing by the MODEM 207, controls the antenna driving unit 208, controls the WG-SW 211, and the like in the portable station 101-1. Note that details about the automatic acquisition control unit 209-1 will be described later.

The power feed splitter 210 is a power feeding demultiplexer that splits a receive signal inputted from the ANT 200 into an H-polarized signal and a V-polarized signal, and outputs the split signals to the WG-SW 211. Conversely, the power feed splitter 210 combines an inputted H-polarized transmit signal and an inputted V-polarized transmit signal, and outputs the combined signal to the ANT 200. Note that in the example of FIG. 9, there is no H-polarized transmit signal, and therefore the power feed splitter 210 outputs only the V-polarized transmit signal outputted from the BUC 203 to the ANT 200.

The WG-SW 211 is a waveguide switch that switches a physical connection in a waveguide under control by the automatic acquisition control unit 209-1. In the example of FIG. 9, an H-polarized receive signal and a V-polarized receive signal outputted from the power feed splitter 210 are inputted into the WG-SW 211. The WG-SW 211 outputs the H-polarized receive signal or the V-polarized receive signal to the LNB 205-1 under control by the automatic acquisition control unit 209-1. Note that FIG. 9 illustrates the state in which the H-polarized output signal from the power feed splitter 210 has been selected by the WG-SW 211.

In FIG. 9, the automatic acquisition control unit 209-1 includes the control unit 301-1, a direction sensor 302, a position sensor 303, a MON 304-1, and a satellite DB 306. In FIG. 9, the blocks (direction sensor 302, position sensor 303, and satellite DB 306) having the same signs as the automatic acquisition control unit 209 according to the first embodiment described in FIG. 5 operate similarly to FIG. 5, and consequently a duplicate description is omitted. Here, the MON 304-1 and the control unit 301-1 will be described.

The automatic acquisition control unit 209 according to the first embodiment in FIG. 5 includes the MON-H 304 that measures the receive level, the frequency, and the bandwidth of an H-polarized signal, and the MON-V 305 that measures the receive level, the frequency, and the bandwidth of a V-polarized signal. In contrast, in the automatic acquisition control unit 209-1 according to the second embodiment in FIG. 9, the single MON 304-1 measures the receive level, the frequency, and the bandwidth of an H-polarized or V-polarized signal selected by the WG-SW 211. In this way, because the portable station 101 according to the first embodiment needs to be provided with separate systems for the H polarization and the V polarization as the receiving system lines, there is a problem of increased device scale of the portable station 101. In contrast, it is sufficient for the portable station 101-1 according to the second embodiment to be provided with the WG-SW 211 having a simple configuration using only a waveguide switch, and because there is just one measuring instrument for measuring the receive level, the frequency, and the bandwidth, the device scale of the portable station 101-1 can be reduced.

Like the control unit 301 in FIG. 5, the control unit 301-1 operates on the basis of a program stored internally in advance, and cooperates with the units of the direction sensor 302, the position sensor 303, the MON 304-1, and the satellite DB 306 to adjust the antenna direction with the antenna driving unit 208 and perform a UAT. In addition, the control unit 301-1 adjusts the transmit level of the BUC 203, controls the MODEM 207, switches the polarization of the WG-SW 211, and the like.

Note that the direction sensor 302, the position sensor 303, and the satellite DB 306 are the same as FIG. 5.

In this way, by switching between the V polarization and the H polarization with the WG-SW 211, the portable station 101-1 according to the second embodiment may be provided with only a single receiving system line, and the single MON 304-1 can be shared in common as a measuring instrument that measures the receive level, the frequency, and the bandwidth for each of H-polarized and V-polarized signals. With this arrangement, the device scale of the portable station 101-1 according to the second embodiment can be reduced compared to the portable station 101 according to the first embodiment.

Next, an example of a UAT process performed after the completion of the antenna direction adjustment in the portable station 101-1 according to the second embodiment will be described.

[Example of UAT Process According to Second Embodiment]

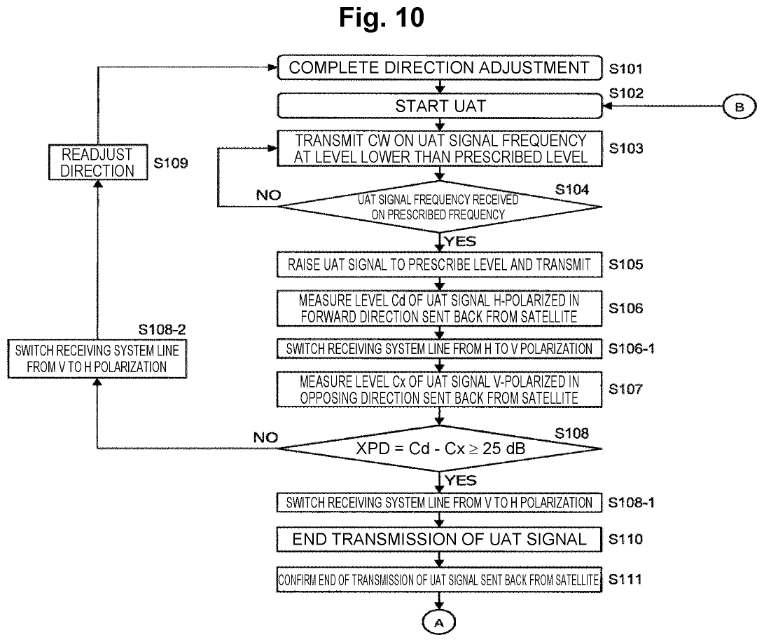

FIG. 10 illustrates an example of a UAT signal checking and adjustment process according to the second embodiment. Note that the process in FIG. 10 corresponds to operations performed between the portable station 101-1 and the communications satellite 103 illustrated in FIG. 1, and is executed by a program stored in advance in the control unit 301-1 of the automatic acquisition control unit 209-1 in the portable station 101-1 illustrated in FIG. 9.

Here, in FIG. 10, steps having the same signs as the portable station 101 according to the first embodiment described in FIG. 7 are the same as FIG. 7, and consequently a duplicate description is omitted.

In the second embodiment, the processes of steps S106-1, S108-1, and S108-2 in FIG. 10 are added. Note that before the process in FIG. 10 is started, it is assumed that the control unit 301-1 of the automatic acquisition control unit 209-1 controls the WG-SW 211 to switch the receiving system line from the V polarization to the H polarization. Here, the receiving system line corresponds to the pathway from the LNB 205-1 to the MON 304-1 downstream from the WG-SW 211 described in FIG. 9.

The process from step S101 to step S106 is the same as the process by the portable station 101 according to the first embodiment in FIG. 7. In the second embodiment, the process in step S106-1 is executed after the execution of the process in step S106.

In step S106-1, the control unit 301-1 controls the WG-SW 211 to switch the receiving system line from the H polarization to the V polarization. This arrangement makes it possible to measure the V-polarized signal on the receiving system line in the next step S107.

In step S108, the control unit 301 determines whether or not the calculated cross-polarization discrimination XPD is at or above a predetermined threshold (for example, XPD≥25 dB). In the case where XPD≥25 dB, the flow proceeds to the process in step S108-1, whereas in the case where XPD<25 dB, it is determined that the adjustment of the antenna direction is incomplete and the flow proceeds to the process in step S108-2 (control process).

In step S108-1, the control unit 301-1 controls the WG-SW 211 to switch the receiving system line from the V polarization to the H polarization. This arrangement makes it possible to measure the H-polarized signal on the receiving system line in the next step S110.

In step S108-2, the control unit 301-1 controls the WG-SW 211 to switch the receiving system line from the V polarization to the H polarization. With this arrangement, the receiving system line is switched to the H polarization of the initial state, and the process in the next step S109 and thereafter can be performed.

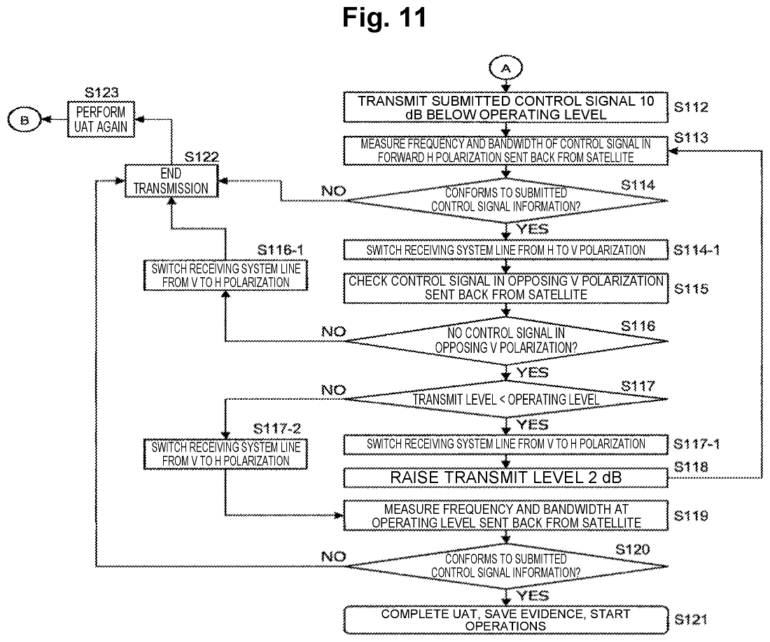

In this way, like the first embodiment, even in the case where a UAT with the satellite telecommunications carrier cannot be performed, the portable station 101-1 according to the second embodiment can receive a UAT signal transmitted by the portable station 101-1 itself and received back from the communications satellite 103 to adjust and check the transmit level and the polarization, similarly to an ordinary UAT. Note that in the process of FIG. 10, because the checking of the UAT signal is completed, the portable station 101-1 performs a process of checking the control signal illustrated in FIG. 11 next.

FIG. 11 illustrates an example of a control signal checking and adjustment process according to the second embodiment. Note that, like FIG. 10, the process in FIG. 11 is executed by a program stored in advance in the control unit 301-1 of the automatic acquisition control unit 209-1 in the portable station 101-1 illustrated in FIG. 9.

Here, in FIG. 11, steps having the same signs as the portable station 101 according to the first embodiment described in FIG. 8 are the same as FIG. 8, and consequently a duplicate description is omitted.

In the second embodiment, the processes of steps S114-1, S116-1, step S117-1, and S107-2 in FIG. 11 are added.

In FIG. 11, the process from step S112 to step S114 is the same as the process by the portable station 101 according to the first embodiment in FIG. 8. In the second embodiment, the process in step S114-1 is executed in the case of YES in the process in step S114.

In step S114-1, the control unit 301-1 controls the WG-SW 211 to switch the receiving system line from the H polarization to the V polarization. This arrangement makes it possible to measure the V-polarized signal on the receiving system line in the next step S115.

Also, the process in step S116-1 is executed in the case of NO in the process in step S116 of FIG. 11.

In step S116-1, the control unit 301-1 controls the WG-SW 211 to switch the receiving system line from the V polarization to the H polarization. With this arrangement, the receiving system line is switched to the H polarization of the initial state, and the process in the next step S122 and thereafter can be performed.

Furthermore, in the case of YES in step S117 in FIG. 11, the process in step S117-1 is executed, and in the case of NO, the process in step S117-2 is executed.

In step S117-1, the control unit 301-1 controls the WG-SW 211 to switch the receiving system line from the V polarization to the H polarization. This arrangement makes it possible to measure the H-polarized signal on the receiving system line in the next step S118.

In step S117-2, the control unit 301-1 controls the WG-SW 211 to switch the receiving system line from the V polarization to the H polarization. This arrangement makes it possible to measure the H-polarized signal on the receiving system line in the next step S119.

Thereafter, the process from step S118 to step S123 is executed similarly to the first embodiment described in FIG. 8.

In this way, even in the case where a UAT with the satellite telecommunications carrier cannot be performed, the portable station 101-1 according to the second embodiment can receive a UAT signal and a control signal transmitted by the portable station 101-1 itself and received back from the communications satellite 103 to adjust and check the transmit level and the polarization of the UAT signal as described in FIG. 10 and also adjust and check the frequency, the polarization, and the bandwidth of the control signal as described in FIG. 11, similarly to an ordinary UAT. Additionally, like the first embodiment, because the portable station 101-1 according to the second embodiment raises the transmit level of the control signal gradually by 2 dB at a time while checking whether or not the control signal conforms to the control signal information submitted to the satellite telecommunications carrier, operations can be started without affecting other satellite communication users.

Particularly, in the second embodiment, a simpler circuit configuration than the first embodiment can be used to measure both the V polarization and the H polarization through the signals sent back from the communications satellite 103 and confirm that the polarization in the opposing direction (opposite polarization) is not being affected. Specifically, by switching between the V polarization and the H polarization with the WG-SW 211, the portable station 101-1 according to the second embodiment may be provided with only a single receiving system line, and because the measuring instrument that measures the receive level, the frequency, and the bandwidth of the H-polarized and V-polarized signals is shared in common, it is sufficient to provide just the single MON 304-1. With this arrangement, the device scale of the portable station 101-1 according to the second embodiment can be reduced compared to the portable station 101 according to the first embodiment.

Here, a program corresponding to the processes described in FIGS. 10 and 11 may also be executed by a computer. In addition, the program may be provided by being recorded onto a storage medium or may be provided over a network.

As described in the embodiments above, the transmission radio wave checking method for a satellite communication system, portable station, and transmission radio wave checking program according to the present invention is capable of completing a UAT by receiving and checking a UAT signal transmitted by a portable station and received back from a satellite, even in cases where a UAT cannot be performed with the satellite telecommunications carrier.

### REFERENCE SIGNS LIST

100 satellite communication system
101, 101-1 portable station (master station)
102 portable station (slave station)
103 communications satellite
200, 400 ANT
201, 401 OMT
202 TX/RX
203, 402 BUC
204 LNB-V
205, 403 LNB-H
205-1 LNB
206 DIV
207, 404 MODEM
208, 405 antenna driving unit
209, 209-1, 406 automatic acquisition control unit
210 power feed splitter
211 WG-SW
301, 301-1, 501 control unit
302, 502 direction sensor
303, 503 position sensor
304 MON-H
304-1 MON
305 MON-V
306 satellite DB
800 satellite communication system
801 portable station
802 base station
803 communications satellite
804 satellite telecommunications carrier
805 control station

1. A transmission radio wave checking method for a satellite communication system provided with a portable station, wherein the portable station executes
a transmission process of transmitting a test signal and a control signal with a first polarization at a designated transmit level to a communications satellite,
a reception process of receiving the test signal and the control signal transmitted back from the communications satellite with a second polarization orthogonal to the first polarization, and
a control process of starting the transmission of the test signal and the control signal with the first polarization at a transmit level lower than a predetermined value, and raising the transmit level to a predetermined value while checking whether or not the test signal and the control signal received back from the satellite conform to a predetermined condition.

2. The transmission radio wave checking method according to claim 1, wherein the control process includes
calculating a cross-polarization discrimination between a receive level of the test signal with the first polarization and a receive level of the test signal with the second polarization, and stopping the test signal if the calculated cross-polarization discrimination is at or above a preset threshold, and
executing a process of starting the transmission of the control signal with the first polarization to the communications satellite at the transmit level lower than an operating level, and raising the transmit level of the control signal gradually until the transmit level reaches the operating level while checking that a frequency and a bandwidth of the control signal transmitted back from the communications satellite with the second polarization orthogonal to the first polarization are respectively prescribed values determined in advance and also checking that the control signal with the first polarization is not received.

3. A portable station used in a satellite communication system, the portable station comprising:
a transmission unit that transmits a test signal and a control signal with a first polarization at a designated transmit level to a communications satellite;
a reception unit that receives the test signal and the control signal transmitted back from the communications satellite with a second polarization orthogonal to the first polarization; and
a control unit that starts the transmission of the test signal and the control signal with the first polarization at a transmit level lower than a predetermined value, and raises the transmit level to a predetermined value while checking whether or not the test signal and the control signal received back from the satellite conform to a predetermined condition.

4. The portable station according to claim 3, wherein the control unit
calculates a cross-polarization discrimination between a receive level of the test signal with the first polarization and a receive level of the test signal with the second polarization, and stops the test signal if the calculated cross-polarization discrimination is at or above a preset threshold, and
executes a process of starting the transmission of the control signal with the first polarization to the communications satellite at a transmit level lower than an operating level, and raising the transmit level of the control signal gradually until the transmit level reaches the operating level while checking that a frequency and a bandwidth of the control signal transmitted back from the communications satellite with the second polarization orthogonal to the first polarization are respectively prescribed values determined in advance and also checking that the control signal with the first polarization is not received.

5. The portable station according to claim 3, further comprising:
an antenna that receives a signal transmitted from the communications satellite;
a switch that selects a receive signal with the first polarization or a receive signal with the second polarization from a receive signal outputted from the antenna; and
a measuring instrument that measures a receive level, a frequency, and a bandwidth of the receive signal with the polarization selected by the switch.

6. A non-transitory computer-readable medium having computer-executable instructions that, upon execution of the instructions by a processor of a computer, cause the computer to function as the transmission radio wave checking method according to claim 1.
